(19) United States
(12) Patent Application Publication
(10) Pub. No.: US 2025/0053775 A1
(43) Pub. Date: Feb. 13, 2025

(54) CRITICAL NODE DETECTION

(71) Applicant: Entanglement, Inc., New York, NY (US)

(72) Inventor: Haibo WANG, Laredo, TX (US)

(73) Assignee: Entanglement, Inc., New York, NY (US)

(21) Appl. No.: 18/795,366

(22) Filed: Aug. 6, 2024

Related U.S. Application Data
(60) Provisional application No. 63/531,283, filed on Aug. 7, 2023.

(51) Int. Cl. G06N 3/04

(52) U.S. Cl. CPC G06N 3/04

(57) ABSTRACT

A computer-implemented method for optimizing neural networks by detecting critical and non-critical nodes is disclosed. The method involves obtaining a neural network comprising a plurality of nodes and their weighted connections. Critical nodes, which have a greater correlation to the network's output than non-critical nodes, are identified through a two-step detection process. The first critical node detection process identifies critical nodes based on weighted direct connections among the nodes. The second critical node detection process identifies critical nodes based on unweighted direct and indirect connections. The configuration of the neural network is then adjusted based on the identified critical and non-critical nodes to improve efficiency or reduce size.

### CROSS-REFERENCE TO RELATED APPLICATION

This application claims the priority of U.S. Provisional Patent Application No. 63/531,283, filed Aug. 7, 2023. The entire content of the above-identified application is incorporated herein by reference.

### TECHNICAL FIELD

The present disclosure relates to the field of neural network optimization and machine learning. More specifically, it pertains to systems and methods for detecting and classifying critical and non-critical nodes within neural networks and other graph-based models.

### BACKGROUND

Neural networks are a fundamental component in various machine learning applications, ranging from image and speech recognition to autonomous systems and natural language processing. The performance and efficiency of these neural networks heavily depend on the configuration and connectivity of their constituent nodes. In a typical neural network, some nodes contribute significantly more to the network's overall functionality and accuracy than others. Identifying these “critical nodes” is essential for optimizing neural network training, improving computational efficiency, and enhancing the robustness of the model.

Traditional approaches to neural network optimization often involve heuristic methods for pruning or reconfiguring networks. However, these methods can be inefficient and may not always yield the most effective results. Moreover, the problem of identifying critical nodes in large-scale networks is computationally intensive and is classified as NP-hard.

This disclosure presents a system and method for critical node detection in neural networks using advanced mixed integer programming (MIP) models and optimization techniques. The system is designed to enhance neural network performance by identifying critical nodes, enabling targeted resource allocation during training and inference, and facilitating effective network pruning. These improvements lead to faster convergence times, reduced computational requirements, and optimized neural network structures suitable for deployment in resource-constrained environments.

### SUMMARY

Some examples described herein may implement systems, methods, and computer-readable media to help identify critical nodes in a neural network. The identification of critical nodes may be identified, for example, in large-scale networks to help accelerate distribution of information through the networks and influence the behavior of the non-critical nodes. The critical and non-critical nodes may be implemented in various technical implementations where neural networks are used, including a large language model.

Critical nodes may be detected by combining two mixed integer programming (MIP) models, including (1) Critical Node Detection based on maximum diversity problem (MDP) with edge weights and (2) Critical Node Detection based on minimum pairwise connectivity problem without edge weights. In some examples, a local metaheuristic based on two-flip method may further refine the detected critical nodes to find the high quality solution for critical node detection.

### BRIEF DESCRIPTION OF DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a critical node detection system, in accordance with some of the embodiments disclosed herein.

FIG. 2 illustrates a neural network generated by the critical node detection system, in accordance with some of the embodiments disclosed herein.

FIG. 3 illustrates a two-flip method executed by the critical node detection system, in accordance with some of the embodiments disclosed herein.

FIG. 4 is a process for Critical Node Detection, in accordance with some of the embodiments disclosed herein.

FIG. 5 is a process for Critical Node Detection based on maximum diversity problem with edge weights, in accordance with some of the embodiments disclosed herein.

FIG. 6 is a process for Critical Node Detection based on minimum pairwise connectivity problem without edge weights, in accordance with some of the embodiments disclosed herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

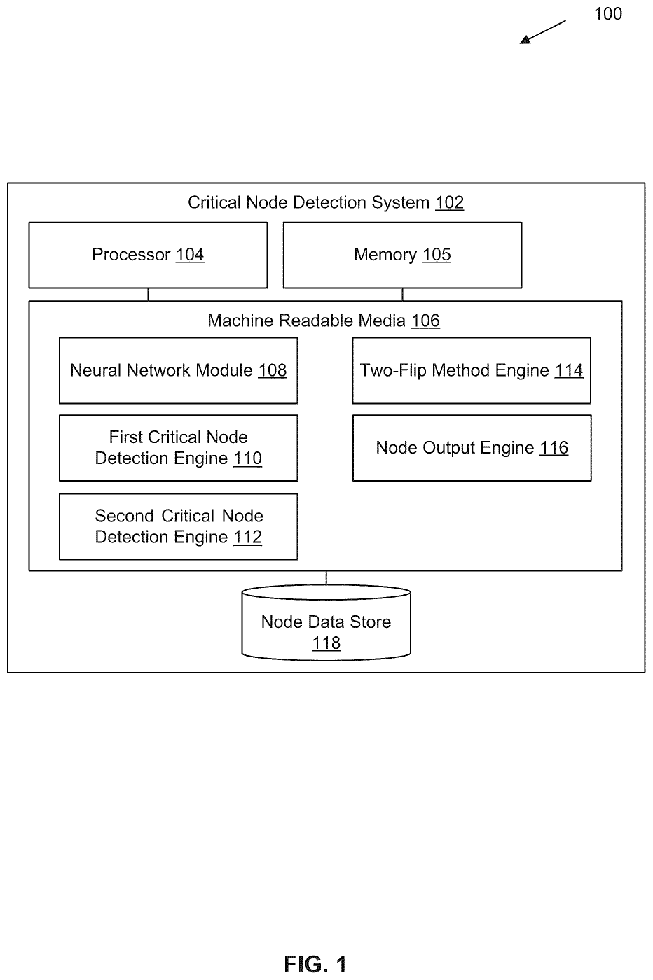

FIG. 1 illustrates a critical node detection system, in accordance with some of the embodiments disclosed herein. In example 100, critical node detection system 102 is configured to determine a critical node in a neural network or other model using processor 104 and store the critical and non-critical nodes in memory 105. Critical node detection system 102 may be implemented as a server computer with processor 104 being an efficient processor like a graphics processing unit (GPU), although such limitations are not required with each embodiment of the disclosure.

Processor 104 may comprise a general-purpose or special-purpose processing engine such as, for example, a microprocessor, controller, or other control logic. Processor 104 may be connected to a bus, although any communication medium can be used to facilitate interaction with other components of critical node detection system 102 or to communicate externally.

Memory 105 may comprise random-access memory (RAM) or other dynamic memory for storing information and instructions to be executed by processor 104. Memory 105 might also be used for storing temporary variables or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, engines, and modules for implementing the functionality discussed herein. Machine readable media 106 may carry one or more sequences of one or more instructions that processor 104 may execute. Such instructions embodied on machine readable media 106 may enable critical node detection system 102 to perform features or functions of the disclosed technology as discussed herein. For example, the interfaces, circuits, and modules of machine readable media 106 may comprise, for example, neural network module 108, first critical node detection engine 110, second critical node detection engine 112, two-flip method engine 114, and node output engine 116. Node data store 118 may store critical nodes and non-critical nodes, as well as other information associated with the neural network.

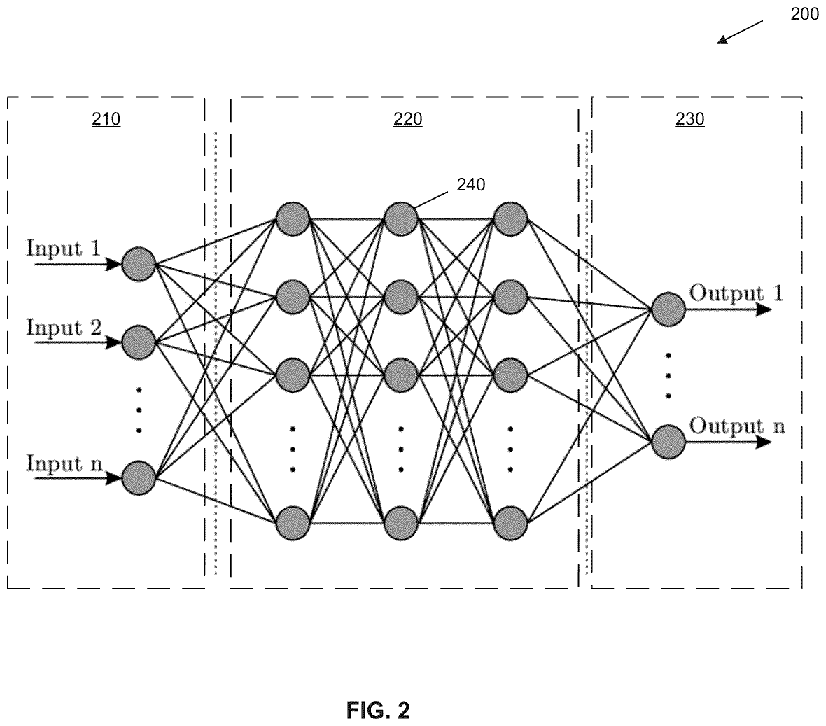

Neural network module 108 is configured to generate a neural network. An illustrative neural network is provided in FIG. 2.

Neural networks comprise a set of processing nodes that are interconnected and weighted. To train the neural network, the weights of the nodes may be initially set to random values. As training data is fed to the first layer of the nodes, the data may pass through the next layers to transform the data to the output layer. During training, the weights and thresholds of each of the nodes may be adjusted until the neural network produces similar outputs for similar training data and labels.

Some of the nodes in the neural network may correspond with a greater correlation to the outcome than other nodes. These nodes may be considered “critical nodes” and the other nodes may be considered “non-critical nodes.” Specifically, critical nodes are those that, if removed, would significantly disrupt the network's structure or functionality. These nodes can have high influence, connectivity, or play pivotal roles in maintaining the network's integrity. Non-critical nodes are those whose removal has minimal impact on the network's overall structure and functionality.

Critical nodes may be detected by using one or more mixed integer programming (MIP) model. Some MIP problems include a constrained decision variable that may require integer values (i.e., whole numbers such as −1, 0, 1, 2, etc.) at the optimal solution, which can allow the MIP model to be constrained by similar limitations.

Various MIP models may be implemented, including (1) Critical Node Detection based on maximum diversity problem (MDP) with edge weights executed by first critical node detection engine 110 and (2) Critical Node Detection based on minimum pairwise connectivity problem without edge weights executed by second critical node detection engine 112.

First critical node detection engine 110 is configured to execute machine-readable instructions to execute a first critical node detection process. In some examples, the (1) Critical Node Detection based on maximum diversity problem (MDP) with edge weights is implemented in detecting critical nodes. The main goal is to determine which nodes in a neural network (or any graph-based model) are critical by analyzing their direct connectivity and the diversity of the direct connections. The MDP approach focuses on maximizing the diversity within clusters of nodes, which helps in distinguishing nodes with significant influence or connectivity from those with less importance.

The process is provided herein with the following notations:

| | |
|---|---|
| G=(V,E) | An undirected network where V is the set of nodes and E the set of edges |
| wᵢⱼ | A signed weight on edge (i,j) ∈ E |
| xᵢⱼ | Equal to 1 if nodes i and j are in the same cluster, 0 otherwise |
| C | Total number of possible nodes to be removed from V |
| C+1 | The index of the cluster that all removed nodes are assigned to |
| xᵢₛ | Equal to 1 if node i is moved to cluster s, s=1,...,C,C+1, 0 otherwise |
| xᵢₛxⱼₛ | Equal to 1 if an edge (i,j) is assigned to a cluster s, s=1,...,C, 0 otherwise; There |
| | cannot be an edge between two nodes in two different clusters s≠ t, for s,t=1,...,C |
| yᵢ | Equal to 1 if node i is removed from V, 0 otherwise |

In some examples, the process may assign all nodes of V to C+1 clusters such that each node is assigned to one cluster, nodes in cluster C+1 cannot be more than C, and no edge can exist between two nodes in two different clusters 1, . . . , C. The process may minimize remaining edges in clusters 1 to C using a linear programming (LP) formulation or a quadratic programming (QP) formulation. C is a positive integer.

Linear programming (LP) formulation:
Min Σ_{i,j∈v} wᵢⱼ xᵢⱼ
Such that: xᵢⱼ + yᵢ + yⱼ ≥ 1, ∀(i, j) ∈ E
Σ_{i∈v} yᵢ ≤ C
xᵢⱼ + xᵢₖ − xⱼₖ ≤ 1 f or all distinct i, j, k ∈ V
Quadratic programming (QP) formulation:
Min Σ_{i,j∈ν} Σₖ₌₁^{C} wᵢⱼxᵢₖxⱼₖ
Such that: Σₖ₌₁^{C + 1} xᵢₖ = 1, ∀i ∈ V
Σ_{i∈v} x_{i,c+1} ≤ C
xᵢₖ + xⱼₗ ≤ 1, ∀(i, j) ∈ E, and k ≠ l = 1, ··· , C

After assigning nodes to clusters 1, . . . , C, C+1, a solver (e.g., Entanglement's solver NGQ™) may be executed to solve the LP or QP formulation to find the solution xᵢⱼ (e.g., an optimal assignment of the nodes into the clusters) that minimizes the respective objective functions, with the constrains comprising that no edges exist between nodes in different clusters 1, . . . , C (note that there may be edges exist between a node from a cluster 1, . . . . C and a node in the cluster C+1). For example, the objective function of the LP formulation is to minimize a sum of the weighted direct connections of nodes within the clusters 1, . . . , C. The solution xᵢⱼ isolates subsets of nodes that have high internal connectivity (critical nodes candidates in clusters 1, . . . , C) from those with low internal connectivity (non-critical nodes in cluster C+1). Nodes with higher connectivity or influence are less likely to be removed to cluster C+1 and more likely to form tight clusters, indicating their critical status. The solver may readjust the assignment of the nodes among the C+1 clusters. With the objective function and the constrains, the non-critical nodes are iteratively moved to cluster C+1.

The use of edge weights in the MDP ensures that the direct connectivity strength (or weighted connections) between nodes is considered. This weighted minimization ensures that nodes across different clusters 1, . . . , C are sufficiently diverse, as reflected by the absence of connections between clusters 1, . . . , C. Within each cluster, the minimization of intra-cluster direct connectivity strength highlights the critical nodes, making the remaining nodes in the clusters 1, . . . , C the representative nodes of their respective sub-portions of the network.

The result of (1) Critical Node Detection based on maximum diversity problem (MDP) with edge weights executed by first critical node detection engine 110 may comprise one or more clusters. In some examples, a cluster of critical nodes can be used to identify the non-critical nodes. For example, the nodes remaining in the clusters 1, . . . , C are considered critical as they play a vital role in the network's overall structure and function. In contrast, the nodes removed to cluster C+1 are considered non-critical.

The result can be incorporated into various practical applications. For example, the non-critical nodes may be removed from the neural network (i.e., network pruning) and redundant resources may be reallocated to improve network resiliency (i.e., computational and/or storage resource reallocation). The cluster of critical nodes may be stored in node data store 118 to access as part of future processes.

Second critical node detection engine 112 is configured to execute machine-readable instructions to execute a second critical node detection process. In some examples, (2) Critical Node Detection based on minimum pairwise connectivity problem (MPCP) without edge weights is implemented. Note that MDP-based Critical Node Detection works with weighted direct connectivity strength between nodes, whereas the MPCP-based Critical Node Detection works with unweighted direct and indirect connectivity between nodes. The process of the MPCP-based Critical Node Detection includes the following notations:

| | |
|---|---|
| G=(V,E) | An undirected network where V is the set of nodes and E the set of edges |
| Pᵢⱼ | The set of all possible paths from node nodes i to j |
| xᵢⱼ | Equal to 1 if nodes i and j are connected by a path in G, 0 otherwise |
| C | The maximum cardinality of nodes in the set B (set B contains the critical nodes) |
| yᵢ | Equal to 1 if and only if node i belongs to the set B, 0 otherwise |

In some embodiments, the clusters with nodes from the first critical node detection process may be provided as input to the second critical node detection process. The second critical node detection process further refines the identification result of the first critical node detection process. In some embodiments, the order of the first critical node detection process and the second critical node detection process may be altered depending on the implementation. In some examples, the second critical node detection process can be solved as maximum independent set, as shown in Model 1 and Model 2 (both may be formulated as Linear Programming (LP) models) provided herein.

Model 1:
Min Σ_{i,j∈v} xᵢⱼ
Such that: xᵢⱼ + yᵢ + yⱼ ≥ 1, ∀(i, j) ∈ E
Σ_{i∈v} yᵢ ≤ C
xᵢⱼ + xᵢₖ − xⱼₖ ≤ 1 f or all distinct i, j, k ∈ V
Model 2:
Min Σ_{i,j∈v} xᵢⱼ
Such that: xᵢⱼ + yᵢ + yⱼ ≥ 1, ∀(i, j) ∈ E
Σ_{i∈v} yᵢ ≤ C
xᵢⱼ + xᵢₖ + xⱼₖ ≠ 2 f or all distinct i, j, k ∈ V

In some embodiments, a solver (e.g., Entanglement's solver NGQ™) may be executed to solve the LP formulation by exploring removal of certain nodes from the set B, in order to minimize the pairwise connectivity of the nodes in the set B. The result generated by the solver includes the nodes remained in the set B, which are deemed as critical nodes.

The main goal of the second critical node detection process is to identify nodes that, when removed, would significantly disrupt the network's connectivity. This is done by focusing on minimizing the pairwise connectivity between nodes without considering edge weights. Nodes that remain highly connected even after minimizing pairwise connectivity are deemed critical because their presence is essential for maintaining the network's structure. Conversely, nodes that can be removed without substantially affecting connectivity are considered non-critical.

In some embodiments, the first critical node detection process and the second critical node detection process may identify their respective critical nodes, which may likely have overlapping nodes. In some embodiments, the critical nodes determined by the first critical node detection process may be refined and/or expanded by the second critical node detection process.

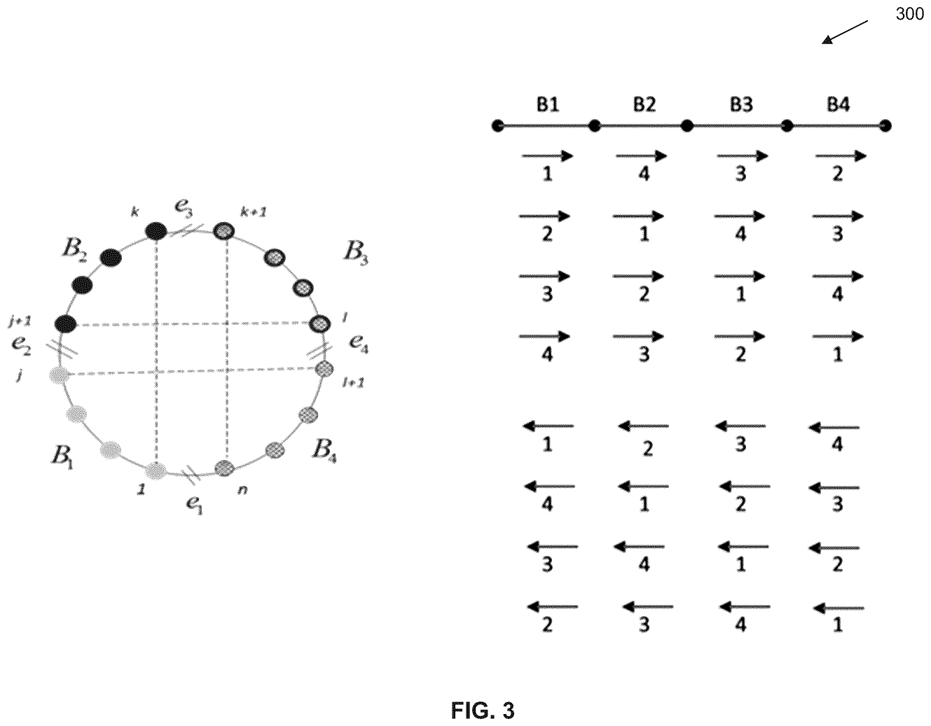

Two-flip method engine 114 is configured to execute machine-readable instructions to execute a two-flip method. For example, the two-flip method splits the decision variables (e.g., the xᵢⱼ and xᵢₖxⱼₖ in the above-described models) into a set of blocks and flips the variables in each block. Here, the flip operation may include exchanging variables in their respective locations and weights. The variables in the first set of sequences may be flipped in a clockwise order until local optimality is found. The variables in the second set of sequences may be flipped in the counterclockwise order until local optimality is found. An illustrative two-flip method executed by two-flip method engine 114 is provided in FIG. 3, in association with the following notations:
N The number of variables
X A binary starting solution with n variables
x* The best solution found so far by an algorithm
f=xQx The value of the objective function for the variable x
f*=x*Qx* The value of the objective function for the best solution found
Jₙₑₓₜ(X) A set of variables, X, where conditions of local optimality
p1, p2 Two integer constants where p1<p2≤n, their values depend on the problem, p2 is defined by the number of critical nodes p2<=C.
Tabu_ten A constant integer number as Tabu tenure (maximum value a variable can remain Tabu)
Tabu (i) for i=1, . . . , n A vector representing Tabu status of feasible solutions.
SEQ-N A sequence of 1, . . . , n

In some examples, a local metaheuristic based on two-flip method may replace one or more portions of the algorithm.

In some examples, a two-flip Local Search embedding Tabu Search method may be implemented by two-flip method engine 114. The method may identify two nodes to exchange for each other in their respective locations and weights. The method may start with the feasible solution on a set of nodes with high network degrees as a cluster of critical nodes. Upon identifying the cluster, the method may flip the variables associated with the node/cluster to move the node into non-critical node clusters and move the node from a non-critical node cluster into the critical node cluster. If the total weight is decreased, then the method may stop (e.g., identifying an optimal solution) or continue to swap the nodes between the critical node cluster and the non-critical node cluster until reaching the time limit, optimized value, or some other threshold value.

In some examples, the method may initialize n, x=a starting feasible solution, x*=x, f=f*=xQx, evaluate the vector E (x), Tabu_ten, Tabu (i)=0, for i=1, . . . , n, SEQ-N. “k” may correspond with a randomly chosen number between p1 and p2, where p2<=C.

The process may comprise the following steps:

| | |
|---|---|
| 1 | Do while (until some stopping criteria, e.g., time limit, is reached) |
| 2 | Do k=p1, p2 |
| 3 | Do while (Jₙₑₓₜ (x) = ∅) |
| 4 | Do i=1, n-1 |
| 5 | L1=SEQ-N(i) |
| 6 | Do j=i+1,n |
| 7 | L2=SEQ-N(j) |
| 8 | If (L1, L2 ∈ Jₙₑₓₜ (x)) Then |
| 9 | f̅ = x̅Qx̅, f or x̅ⱼ = xⱼ |
| 10 | If (((Tabu(L1)=0)and Tabu(L2)=0) or (f̅>f*)) Then |
| 11 | x_{L1} = 1 − x_{L1}, x_{L2} = 1 − x_{L2}, |
| 12 | Update:Jₙₑₓₜ (x) and Tabu(j) |
| 13 | f = f̅ |
| 14 | If (f̅>f*) f*=f̅, |
| 15 | End If |
| 16 | Update: J ₙₑₓₜ (X), Tabu(j), for j=1,...,n |
| 17 | End If |
| 18 | End do |
| 19 | End do |
| 20 | Call UPDATE SEQ-N(.) |
| 21 | End while |
| 22 | Call rand_var_change(.) |
| 23 | End do |
| 24 | End while |

The Two-Flip Method Engine 114 and the two critical node detection processes work together to provide a comprehensive approach to identifying critical nodes in a neural network. The first critical node detection process, based on the Maximum Diversity Problem (MDP) with Edge Weights, aims to identify nodes that are essential for maintaining the internal structure of clusters. It does this by maximizing diversity within clusters and minimizing internal weighted direct connectivity based on the strength of the edges. The second process, based on the Minimum Pairwise Connectivity Problem (MPCP) without considering edge weights, focuses on minimizing overall connectivity (direct connections between adjacent nodes and indirect connections between non-adjacent nodes) between nodes. This process ensures that nodes essential for the network's overall connectivity are identified as critical by evaluating their importance in maintaining paths within the network.

The Two-Flip Method Engine 114 further complements these processes by providing an iterative optimization mechanism. After the initial identification of critical nodes by the MDP and MPCP, the Two-Flip Method Engine 114 refines these results. It achieves this by iteratively flipping variables, or nodes, between clusters to explore different configurations of node classifications (i.e., critical or non-critical) and find a local optimal solution. By embedding a Tabu Search method, the engine 114 avoids revisiting previously explored suboptimal solutions, thereby enhancing the search for the most impactful critical nodes.

Node output engine 116 is configured to provide an identification of a critical node or a non-critical node, based on the methods described herein for detecting such nodes.

In some examples, critical nodes may be implemented in neural networks in various environments. For example, real-world dynamic and evolutionary physical and digital systems are represented by complex networks. Business can reduce the cost of communication and communication complexity by identifying critical nodes in the complex network. The stability and efficacy of complex networks rely on a subset of nodes, known as critical nodes.

Technical advantages are provided throughout the disclosure. For example, the determination of critical nodes can accelerate the information spread through the networks and influence the behavior of the non-critical nodes in various context, including in the large language model. The calculation of weight pruning on the critical node(s) can also reduce the computational resources on semantic network and knowledge graph. However, the critical node detection problem of large-scale networks is NP-hard in general including semantic network and knowledge graph. By implementing at least two mixed integer programming (MIP) models for critical node detection, both models can be solved efficiently and in parallel using a quantum optimization device (e.g., Entanglement's solver NGQ™).

There are various practical application of the critical node detection in a neural network, generally related to reconfiguring the neural network for efficiency improvement and/or size reduction. In neural network training, the training algorithms can prioritize adjusting critical nodes' weights and biases, leading to faster convergence towards an optimal model. For example, different learning rates can be applied to critical and non-critical nodes. Critical nodes can be trained with a higher learning rate to expedite the learning process, while non-critical nodes can be trained with a lower learning rate or even frozen to save computational resources. This targeted approach reduces the training time and enhances the learning efficiency by focusing computational resources where they are most impactful.

As another example, identifying non-critical nodes allows for effective network pruning, which involves removing less significant nodes without compromising the network's performance. This results in a more compact and faster network with fewer parameters to update during training and inference. Pruning enhances computational efficiency and reduces the model's memory footprint, making the network more suitable for deployment in resource-constrained environments like mobile devices or other edge devices (e.g., Internet of Things devices).

During inference, especially in deep neural networks, computational resources can be allocated more effectively by focusing on critical nodes. For example, once critical nodes are identified, computational resources can be strategically allocated to these nodes during the inference process. This means that more processing power, memory, and computational time are focused on analyzing and processing these critical nodes rather than uniformly distributing resources across all nodes. This approach ensures that the computational power is not wasted on processing non-critical information, thus speeding up the inference process without loss of accuracy. In practical terms, this approach is particularly useful in scenarios where processing speed is critical, such as in real-time systems or applications running on limited-resource devices like mobile phones or embedded systems. By optimizing the way computational resources are used during inference, these systems can operate more swiftly and efficiently.

Furthermore, a person skilled in the art would appreciate that the above-described critical node detection in a neural network can be applied to more generic weighted and directed networks. The methods and steps outlined for identifying critical nodes in neural networks, such as analyzing node connectivity, direct and indirect influences, and the application of mixed integer programming (MIP) models, are equally applicable to other types of weighted and directed networks.

In these more general networks, nodes represent entities or points within the system, while the weighted, directed edges signify the strength and direction of relationships or interactions between them. For instance, in a transportation network, nodes could represent hubs or cities, and edges could represent the routes between them, weighted by factors such as distance, cost, or capacity. The critical node detection process can be used to identify which hubs are most essential for maintaining efficient transport flows, and which routes are most susceptible to disruptions that could cause widespread inefficiencies.

Similarly, in communication networks, nodes could represent servers or data centers, and the edges could signify data flow or bandwidth, weighted by traffic volume or latency. Identifying critical nodes in such a network would help in enhancing the robustness of the network by focusing on key points that ensure data integrity and flow.

By extending the methods of critical node detection from neural networks to other weighted and directed networks, it becomes possible to analyze and optimize a wide range of complex systems. This approach allows for the identification of key nodes that, if disrupted, would significantly impact the functionality or efficiency of the network, making the methodology versatile and applicable across various fields.

For instance, critical node detection technology offers significant advantages across various domains, including logistics, emergency management, and the financial system. By identifying key nodes that are crucial to the integrity and functionality of networks in these fields, organizations can optimize their operations, enhance resilience, and mitigate risks effectively.

In the logistics sector, critical node detection can be instrumental in identifying bottlenecks within transportation networks. These bottlenecks, often caused by highly utilized or strategically important routes, can significantly impact the efficiency and reliability of the entire logistics operation. By pinpointing these critical nodes, logistics companies can reconfigure their networks, allocate resources more effectively, and implement targeted strategies to alleviate congestion and improve the flow of goods. This approach not only enhances overall efficiency but also reduces operational costs and ensures timely deliveries, which are crucial in today's fast-paced supply chain environment.

In emergency management, critical node detection may play a critical role in assessing the resilience of critical infrastructure systems, such as power grids, water supply networks, and communication systems. By identifying the most vulnerable or essential nodes within these infrastructures, authorities can prioritize their efforts to strengthen these points, ensuring that the system remains operational during crises. For example, in the event of a natural disaster, maintaining the functionality of these critical nodes can prevent cascading failures, allowing for a more effective and coordinated response. This capability is essential for enhancing the resilience of communities and ensuring the continuity of essential services during emergencies.

In the financial system, critical node detection can identify key institutions or connections that are pivotal to the stability of the entire financial network. These critical nodes may represent banks or financial institutions that are central to the flow of transactions or the distribution of liquidity. By recognizing these nodes, regulators and financial institutions can implement safeguards to protect against systemic risks, such as cascading failures or financial contagions. This proactive approach helps to maintain the stability of the financial system, ensuring that disruptions at critical points do not lead to widespread economic consequences.

FIG. 2 illustrates a neural network generated by the critical node detection system, in accordance with some of the embodiments disclosed herein. In example 200, the neural network may comprise input layer 210, hidden layers 220, and output layer 230. Each of these layers may comprise a set of nodes, including node 240, that can be determined to be a critical node or a non-critical node.

FIG. 3 illustrates a two-flip method executed by the critical node detection system. In example 300, two-flip method engine 114 may initiate the two-flip method by randomly choosing three numbers between 1 and “n,” with “C” as one of the numbers. Two-flip method engine 114 creates four blocks of variables (B1, B2, B3 and B4) with eight sequences (four sequences for clockwise flip, and four sequences for counterclockwise flip). As illustrated, the method may start from B1 and rotate clockwise to flip the set of variables from x to 1-x until the local optimality is found. Two-flip method engine 114 may apply a two-flip to variables in B2 to rotate clockwise until the local optimality is found. The first set of sequences implements two-flip to variables in clockwise order, and the second set of sequences applies two-flip to variables in the counterclockwise order.

In some examples, two-flip method engine 114 can execute the two-flip method in parallel on each set of sequences. It may be an exhaustive search method to find high quality local optimal solution without keeping high quality feasible solutions in the memory.

In some examples, the two-flip method can be embedded with a Tabu Search iteration. Tabu Search is a metaheuristic search method used to solve combinatorial optimization problems. The key idea behind Tabu Search is to iteratively explore the solution space while avoiding cycles and local optima by keeping track of previously visited solutions (or attributes of these solutions) using a memory structure called the “tabu list.” The tabu list temporarily forbids or penalizes certain moves or solutions that would lead to revisiting recently explored areas of the solution space, encouraging the algorithm to explore new and potentially better solutions. This helps the search process escape local optima and increases the likelihood of finding a global optimum or a better overall solution.

In these examples, the high-quality solutions may be stored in the Tabu list, which can be controlled by the value of Tabu tenure. The value of Tabu tenure is set by an administrative user or other decision maker based on prior experience.

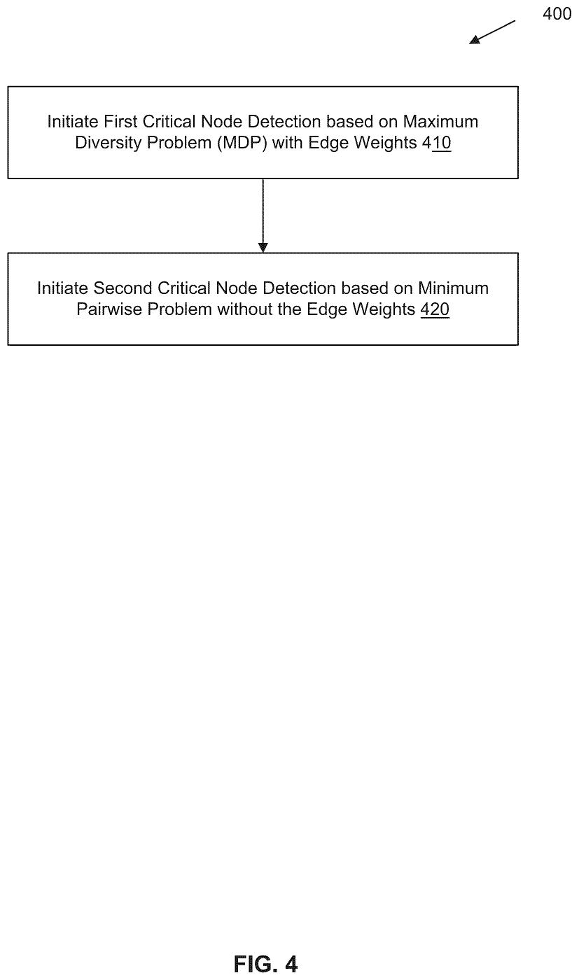

FIG. 4 is a process for Critical Node Detection, in accordance with some of the embodiments disclosed herein. Process 400 may be executed by critical node detection system 102 of FIG. 1. Block 410 may initiate a first critical node detection based on maximum diversity problem (MDP) with edge weights. Block 420 may initiate a second critical node detection based on minimum pairwise problem without the edge weights.

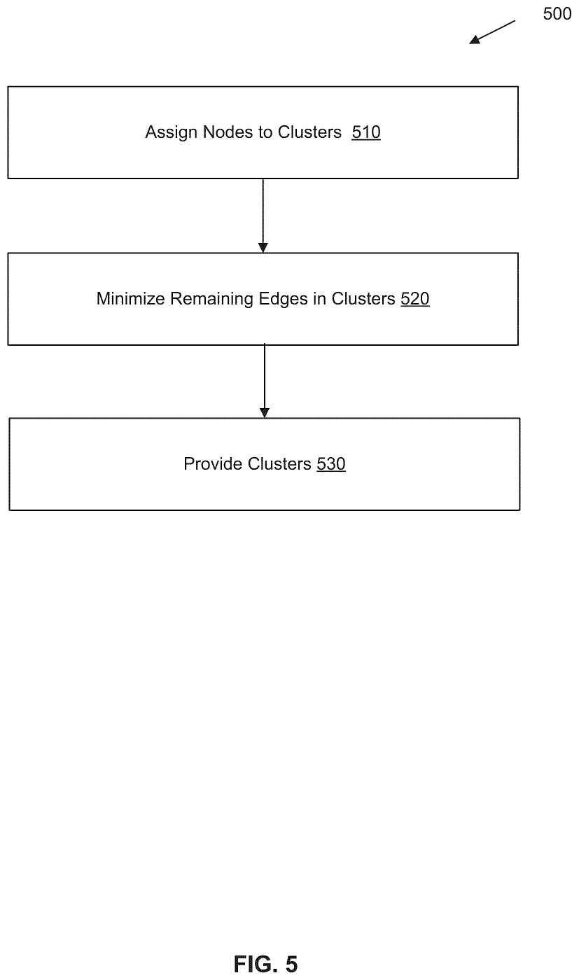

FIG. 5 is a process for Critical Node Detection based on maximum diversity problem with edge weights, in accordance with some of the embodiments disclosed herein. Process 500 may be executed by critical node detection system 102 of FIG. 1. Block 510 may assign nodes to clusters. For example, the process may assign all nodes of V to C+1 clusters such that each node is assigned to one cluster, nodes in cluster C+1 cannot be more than C, and no edge can exist between two nodes in two different clusters 1, . . . , C. Block 520 may minimize remaining edges in clusters. For example, the process may minimize remaining edges in clusters 1 to C using a linear programming (LP) formulation or a quadratic programming (QP) formulation provided herein. Block 530 may provide critical node clusters or non-critical node clusters to a memory or other data store.

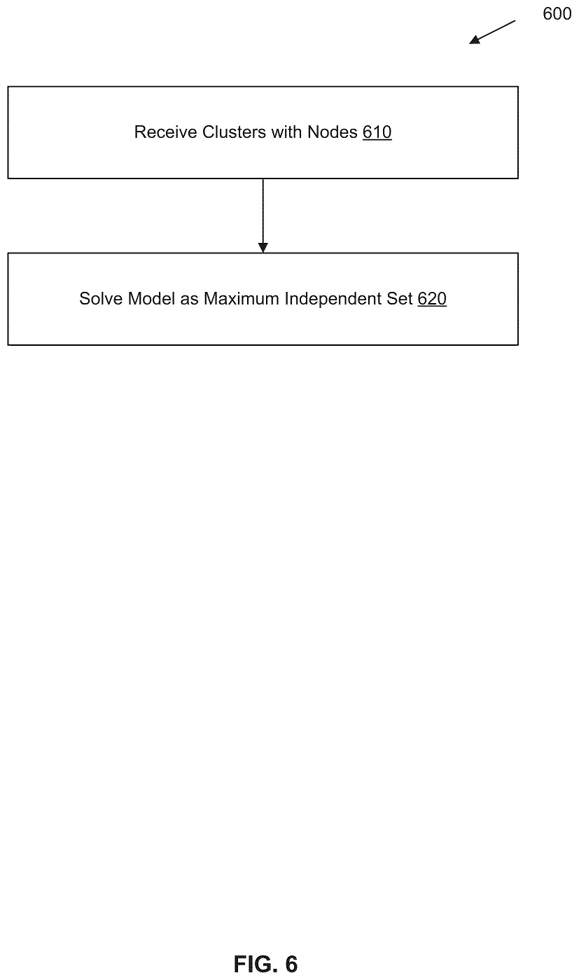

FIG. 6 is a process for Critical Node Detection based on minimum pairwise connectivity problem without edge weights, in accordance with some of the embodiments disclosed herein. Process 600 may be executed by critical node detection system 102 of FIG. 1. Block 610 may receive one or more clusters of nodes as input to the second critical node detection process. The second critical node detection may be based on minimum pairwise connectivity problem without edge weights. Block 620 may solve the model as a maximum independent set using one of the two models provided herein.

The process may be implemented by a computer system. The computer system may include a bus or other communication mechanism for communicating information, one or more hardware processors coupled with the bus for processing information. The hardware processor(s) may be, for example, one or more general purpose microprocessors.

The computer system also includes a main memory, such as a random access memory (RAM), cache and/or other dynamic storage devices, coupled to the bus for storing information and instructions to be executed by the processor. The main memory also may be used for storing temporary variables or other intermediate information during execution of instructions to be executed by the processor. Such instructions, when stored in storage media accessible to the processor, render the computer system into a special-purpose machine that is customized to perform the operations specified in the instructions.

The computer system further includes a read only memory (ROM) or other static storage device coupled to the bus for storing static information and instructions for the processor. A storage device, such as a magnetic disk, optical disk, or thumb drive, may be coupled to the bus for storing information and instructions.

The computer system may be coupled via the bus to a display, such as a liquid crystal display (LCD), for displaying information to a computer user. An input device, including alphanumeric and other keys, is coupled to the bus for communicating information and command selections to the processor. Another type of user input device is a mouse, a trackball, or cursor direction keys for communicating direction information and command selections to the processor and for controlling cursor movement on the display. In some embodiments, the same direction information and command selections as cursor control may be implemented via receiving touches on a touch screen without a cursor.

The computing system may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system may implement the techniques described herein using customized hard-wired logic, one or more ASICs or FPGAs, firmware and/or program logic which in combination with the computer system causes or programs the computer system to be a special-purpose machine. According to one embodiment, the techniques herein are performed by the computer system in response to the processor(s) executing one or more sequences of one or more instructions contained in the main memory. Such instructions may be read into the main memory from another storage medium. Execution of the sequences of instructions contained in the main memory causes the processor(s) to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks. Volatile media includes dynamic memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise a bus. Transmission media can also take the form of acoustic or light waves, such as those generated during radio-wave and infra-red data communications.

The computer system also includes a communication interface coupled to the bus. The interface provides a two-way data communication coupling to one or more network links that are connected to one or more local networks. For example, the interface may be an integrated services digital network (ISDN) card, cable modem, satellite modem, or a modem to provide a data communication connection to a corresponding type of telephone line. As another example, the interface may be a local area network (LAN) card to provide a data communication connection to a compatible LAN (or WAN component to communicated with a WAN). Wireless links may also be implemented. In any such implementation, the interface sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through an interface, which carry the digital data to and from the computer system, are example forms of transmission media.

The computer system can send messages and receive data, including program code, through the network(s), network link and interface. In the Internet example, a server might transmit a requested code for an application program through the Internet, the ISP, the local network and the interface.

The received code may be executed by the processor as it is received, and/or stored in the storage device, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
obtaining a neural network comprising a plurality of nodes and weighted connections;
identifying one or more critical nodes of the neural network from the plurality of nodes, wherein the one or more critical nodes have a greater correlation to an output of the neural network than other non-critical nodes, wherein the identifying comprises:
executing a first critical node detection process to identify first critical nodes based on weighted direct connections among the plurality of nodes;
executing a second critical node detection process to identify second critical nodes based on unweighted direct and indirect connections among the plurality of nodes; and
adjusting a configuration of the neural network based on the identified critical nodes and non-critical nodes in the neural network for efficiency improvement or size reduction.

2. The method of claim 1, wherein the first critical node detection process comprises:
assigning the plurality of nodes into C+1 clusters, wherein C is a positive integer, clusters 1, . . . , C are configured to store critical node candidates, and cluster C+1 is configured to store non-critical node candidates;
constructing a linear programming (LP) formulation or a Quadratic programming (QP) formulation with objective functions to find a new assignment of the plurality of nodes; and
executing a solver to solve the LP formulation or the QP formulation to determine the new assignment of the plurality of nodes that minimizes a sum of the weighted direct connections of nodes within clusters 1, . . . , C; and
identifying the critical nodes based on the new assignment of the plurality of the plurality of nodes.

3. The method of claim 2, wherein identifying the critical nodes based on the new assignment of the plurality of the plurality of nodes comprises:
determining nodes assigned to clusters 1, . . . , C in the new assignment as the critical nodes; and
determining nodes assigned to cluster C+1 in the new assignment as the non-critical nodes.

4. The method of claim 1, wherein an output of the first critical node detection process is used as an input of the second critical node detection process, wherein the second critical node detection process further refines the identification result of the first critical node detection process.

5. The method of claim 1, wherein the second critical node detection process comprises:
constructing an LP formulation with an objective function to find a set of nodes from the plurality of nodes, wherein the objective function is designed to minimize pairwise connectivity between the set of nodes by considering direct connections between adjacent nodes and indirect connections between non-adjacent nodes, irrespective of connection weights
executing a solver to solve the LP formulation to remove non-critical nodes from the set of nodes; and
obtaining the critical nodes in the set of nodes as a result of the execution.

6. The method of claim 1, further comprising:
performing a two-flip process to iteratively flip the identified critical nodes to explore different classification of the critical nodes and the critical nodes.

7. The method of claim 1, wherein the adjusting the configuration of the neural network based on the identified critical nodes and non-critical nodes in the neural network comprises:
during training of the neural network, prioritizing adjustment of weights and biases of the critical nodes to accelerate convergence and reduce training time.

8. The method of claim 1, wherein the adjusting the configuration of the neural network based on the identified critical nodes and non-critical nodes in the neural network comprises:
pruning the neural network based on the non-critical nodes to reduce memory footprint of the neural network, facilitating deployment of the neural network on mobile devices and edge devices.

9. The method of claim 1, wherein the adjusting the configuration of the neural network based on the identified critical nodes and non-critical nodes in the neural network comprises:
during an inference process using the neural network, allocating computational resources by focusing on the critical nodes, thereby speeding up the inference process, wherein the computational resources comprise processing power and memory resource.

10. The method of claim 1, further comprising:
during a training process, assigning a higher learning rate to the critical nodes and a lower learning rate to the non-critical nodes, resulting in faster convergence.

11. The method of claim 1, wherein the first critical nodes and the second critical nodes have overlapping nodes.

12. A non-transitory computer-readable storage medium including instructions that, when executed by at least one processor of a computing system, cause the computing system to perform operations comprising:
obtaining a neural network comprising a plurality of nodes and weighted connections;
identifying critical nodes of the neural network from the plurality of nodes, wherein the critical nodes have a greater correlation to an output of the neural network than other non-critical nodes, wherein the identifying comprises:
executing a first critical node detection process to identify first critical nodes based on weighted direct connections among the plurality of nodes;
executing a second critical node detection process to identify second critical nodes based on unweighted direct and indirect connections among the plurality of nodes; and
adjusting a configuration of the neural network based on the identified critical nodes and non-critical nodes in the neural network for efficiency improvement or size reduction.

13. The non-transitory computer-readable storage medium of claim 12, wherein the first critical node detection process comprises:
assigning the plurality of nodes into C+1 clusters, wherein C is a positive integer, clusters 1, . . . , C are configured to store critical node candidates, and cluster C+1 is configured to store non-critical node candidates;
constructing a linear programming (LP) formulation or a Quadratic programming (QP) formulation with objective functions to find a new assignment of the plurality of nodes; and
executing a solver to solve the LP formulation or the QP formulation to determine the new assignment of the plurality of nodes that minimizes a sum of the weighted direct connections of nodes within clusters 1, . . . , C; and
identifying the critical nodes based on the new assignment of the plurality of the plurality of nodes.

14. The non-transitory computer-readable storage medium of claim 12, wherein the second critical node detection process comprises:
constructing an LP formulation with an objective function to find a set of nodes from the plurality of nodes, wherein the objective function is designed to minimize pairwise connectivity between the set of nodes by considering direct connections between adjacent nodes and indirect connections between non-adjacent nodes, irrespective of connection weights
executing a solver to solve the LP formulation to remove non-critical nodes from the set of nodes; and
obtaining the critical nodes in the set of nodes as a result of the execution.

15. The non-transitory computer-readable storage medium of claim 12, wherein the adjusting the configuration of the neural network based on the identified critical nodes and non-critical nodes in the neural network comprises:
during training of the neural network, prioritizing adjustment of weights and biases of the critical nodes to accelerate convergence and reduce training time.

16. The non-transitory computer-readable storage medium of claim 12, wherein the adjusting the configuration of the neural network based on the identified critical nodes and non-critical nodes in the neural network comprises:
pruning the neural network based on the non-critical nodes to reduce memory footprint of the neural network, facilitating deployment of the neural network on mobile devices and edge devices.

17. The non-transitory computer-readable storage medium of claim 12, wherein the adjusting the configuration of the neural network based on the identified critical nodes and non-critical nodes in the neural network comprises:
during an inference process using the neural network, allocating computational resources by focusing on the critical nodes, thereby speeding up the inference process, wherein the computational resources comprise processing power and memory resource.

18. A system comprising:
at least one processor; and
a memory storing instructions that, when executed by the at least one processor, cause the system to perform operations comprising:
obtaining a neural network comprising a plurality of nodes and weighted connections;
identifying critical nodes of the neural network from the plurality of nodes, wherein the critical nodes have a greater correlation to an output of the neural network than other non-critical nodes, wherein the identifying comprises:
executing a first critical node detection process to identify first critical nodes based on weighted direct connections among the plurality of nodes;
executing a second critical node detection process to identify second critical nodes based on unweighted direct and indirect connections among the plurality of nodes; and
adjusting a configuration of the neural network based on the identified critical nodes and non-critical nodes in the neural network for efficiency improvement or size reduction.

19. The system of claim 18, wherein the first critical node detection process comprises:
assigning the plurality of nodes into C+1 clusters, wherein C is a positive integer, clusters 1, . . . , C are configured to store critical node candidates, and cluster C+1 is configured to store non-critical node candidates;
constructing a linear programming (LP) formulation or a Quadratic programming (QP) formulation with objective functions to find a new assignment of the plurality of nodes; and
executing a solver to solve the LP formulation or the QP formulation to determine the new assignment of the plurality of nodes that minimizes a sum of the weighted direct connections of nodes within the clusters 1, . . . , C; and
identifying the critical nodes based on the new assignment of the plurality of the plurality of nodes.

20. The system of claim 18, wherein the second critical node detection process comprises:
constructing an LP formulation with an objective function to find a set of nodes from the plurality of nodes, wherein the objective function is designed to minimize pairwise connectivity between the set of nodes by considering direct connections between adjacent nodes and indirect connections between non-adjacent nodes, irrespective of connection weights
executing a solver to solve the LP formulation to remove non-critical nodes from the set of nodes; and
obtaining the critical nodes in the set of nodes as a result of the execution.
